(19) United States
(12) Patent Application Publication
(10) Pub. No.: US 2014/0176314 A1
(43) Pub. Date: Jun. 26, 2014

(54) Smart Device to Media Device Coupling to Create Virtual Control Environment

(71) Applicant: INTERNATIONAL BUSINESS MACHINES CORPORATION, Armonk, NY (US)

(72) Inventors: Carlos E. Hoyos, Morrisville, NC (US); Charles Steven Lingafelt, Durham, NC (US)

(73) Assignee: International Business Machines Corporation, Armonk, NY (US)

(21) Appl. No.: 13/725,542

(22) Filed: Dec. 21, 2012

(51) Int. Cl. G08C 19/16

(52) U.S. Cl. CPC G08C 19/16
USPC 340/12.52

(57) ABSTRACT

An embodiment of the invention provides a method including receiving in an antenna of a smart device first wireless command and control data from a first electronic device. The antenna receives additional wireless command and control data from at least one second electronic device. The first wireless command and control data and the additional wireless command and control data are automatically received from the first electronic device and the at least one second electronic device without input to the smart device from a user. A universal interface is created in the smart device based on the first command and control data and the additional command and control data, wherein the first electronic device and the at least one second electronic device are controllable by the universal interface.

### BACKGROUND

The present invention is in the field of systems, devices, methods, and computer program products for smart device to media device coupling to create virtual control environment.

Universal remote control units have gained widespread popularity for use in the home to control a variety of electronic devices such as television sets, cable boxes or converters, satellite receiver boxes, stereo systems, ceiling fans, floor fans, video recorders of both the cassette and digital variety, digital video disc players and many, many more devices such as ovens, irons, monitors, lights, heating, ventilating, air conditioning, security, cooking, alarms and an ever-growing list of devices employed in digitally controlled home environments.

The universality of the remote control units is due to their programmability for controlling a plurality of devices. Remote control units are typically programmed via user input. Specifically, codes provided by device manufacturers are manually entered into the remote control unit by the user. The codes are often a series of numbers entered by the user via a keypad on the remote control unit.

### SUMMARY OF THE INVENTION

An embodiment of the invention provides a method for creating a virtual control environment wherein first electronic signals are received in an antenna of a smart device, the first electronic signals including first wireless command and control data from a first electronic device. The first command and control data includes a first menu for controlling the first media device, and a first screen layout for controlling the first media device. The wireless command and control data is automatically received from the first electronic device without input to the smart device from a user.

Additional electronic signals are received in the antenna of the smart device, wherein the additional electronic signals include additional wireless command and control data from one or more second electronic devices. The additional command and control data includes an additional menu for controlling the second media device(s), and an additional screen layout for controlling the second media device(s). The additional wireless command and control data is automatically received from the second electronic device(s) without input to the smart device from the user.

A universal interface is created in the smart device based on the first command and control data and the additional command and control data, wherein the first electronic device and the second electronic device(s) are controllable by the universal interface. The universal interface includes multiple control menus for displaying on a display of the smart device, the control menus including control screens supplied by the first media device and the second media device(s).

In another embodiment of the invention, a smart device receives first wireless command and control data from a first electronic device. A first interface is created in the smart device based on the first command and control data, wherein the first electronic device is controllable by the first interface. Additional wireless command and control data from one or more second electronic devices is received by the smart device. A second interface is created in the smart device based on the additional command and control data, wherein the second electronic device(s) are controllable by the second interface.

Another embodiment of the invention provides a smart device having an antenna for receiving first wireless command and control data from a first electronic device and additional wireless command and control data from at least one second electronic device. The first wireless command and control data includes a first menu for controlling the first electronic device, and a first screen layout for controlling the first electronic device. The additional wireless command and control data includes an additional menu for controlling the second electronic device(s), and an additional screen layout for controlling the second electronic device(s).

A processor is connected to the antenna, wherein the processor creates a universal interface based on the first command and control data and the additional command and control data. The universal interface controls functions of the first electronic device and the second electronic device(s), wherein the universal interface includes multiple control menus having control screens supplied by the first electronic device and the second electronic device(s). A display is connected to the processor for displaying the universal interface to a user.

Yet another embodiment of the invention provides a device including an antenna for receiving first wireless command and control data from a first electronic device and additional wireless command and control data from second electronic device(s). A processor is connected to the antenna for creating a first interface based on the first wireless command and control data, wherein the first interface controls functions of the first electronic device. The processor also creates a second interface based on the additional wireless command and control data, wherein the second interface controls functions of the second electronic device(s). A display is connected to the processor for displaying the first interface and/or the second interface to a user.

### BRIEF DESCRIPTION OF THE SEVERAL VIEWS OF THE DRAWINGS

The present invention is described with reference to the accompanying drawings. In the drawings, like reference numbers indicate identical or functionally similar elements.

FIG. 1 is a flow diagram illustrating a method for controlling electronic devices according to an embodiment of the invention;

FIG. 2 is a flow diagram illustrating a method for controlling electronic devices according to another embodiment of the invention;

FIG. 3 is a flow diagram illustrating a method for controlling electronic devices according to yet another embodiment of the invention;

FIG. 4 is a flow diagram illustrating a method for controlling electronic devices according to still another embodiment of the invention;

FIG. 5 illustrates a device for controlling electronic devices according to an embodiment of the invention;

FIG. 6 illustrates a device for controlling electronic devices according to another embodiment of the invention; and

FIG. 7 illustrates a computer program product according to an embodiment of the invention.

### DETAILED DESCRIPTION

Exemplary, non-limiting, embodiments of the present invention are discussed in detail below. While specific configurations are discussed to provide a clear understanding, it should be understood that the disclosed configurations are provided for illustration purposes only. A person of ordinary skill in the art will recognize that other configurations may be used without departing from the spirit and scope of the invention.

An embodiment of the invention creates a virtual universal remote control (URC) unit with dynamic coupling environments between media devices and smart devices, thus allowing the smart device to present a set of screens that are used to control the operations of the media devices. The virtual URC unit enables an exchange of information between media and smart devices to dynamically configure command and control screens. Although the example embodiments in this disclosure specifically reference “media devices” (also referred to herein as “electronic devices”), it is recognized that the virtual URC unit can be used with other types of electronic devices, including but not limited to, for example, ceiling fans, floor fans, lights, thermostats (heating and/or cooling systems), fireplaces, kitchen appliances (e.g., oven, stove, microwave), and/or security systems.

The virtual URC unit provides a mechanism for a media device to transfer information to a smart device (e.g., over a common protocol such as Bluetooth) to inform the smart device what command codes the media device utilizes along with a logical control layout and menu system. This creates a virtual URC environment, which allows a smart device to be moved between media devices and to dynamically reconfigure it's control screens to adapt to the media devices to which it is coupled. This removes the requirement of user interaction to program or reprogram their control device.

The virtual URC unit negates obsolescence of control devices and provides greater flexibility for the end user. This allows the smart device to display a more native control layout for the media device and reduces or eliminates end user programming. Moreover, the virtual URC unit allows for a virtually unlimited number of media devices to be controlled. In at least one embodiment, the virtual URC determines the type of media device that is in range of the virtual URC from signals received by the media device, wherein the virtual URC displays a generic/common interface that is used to the identified device type (e.g., DVD player).

At least one embodiment of the invention provides a method for controlling media devices, wherein the media devices negotiate with and automatically load smart devices with control codes, overlays, management screens, and/or templates to allow for controlling of the media devices remotely. Templates and overlays can be downloaded to the smart device; and, software on the media devices can be updated to change control structures at any time, thereby allowing for media device functionality to be enhanced without a need for a new remote control device. The method provides the ability to move from domain to domain, literally adapting to new environments as the smart device moves from location to location. For example, a user could move from his living room to a hotel room and still be able to adapt to and control devices in the new environment.

The media devices can automatically broadcast their presence/proximity in a “I am here” function over a set interval. In another embodiment, device linkage is initiated by the smart device when it comes in range of the media devices and discovers their presence. In either situation, control codes, overlays, etc. can be uploaded to the smart device for control.

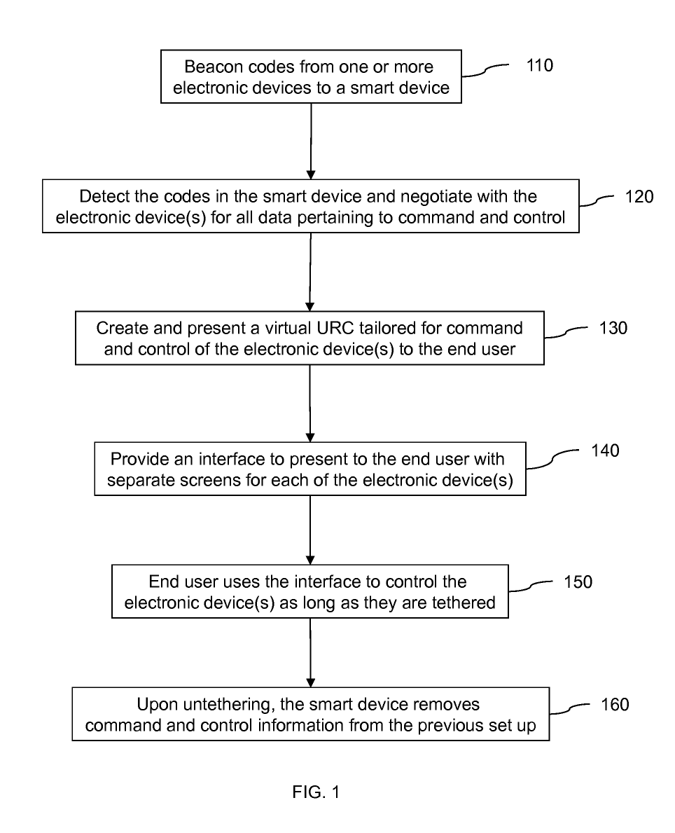

FIG. 1 is a flow diagram illustrating a method for controlling electronic devices (also referred to herein as “media devices”) according to an embodiment of the invention. Upon receiving power, the electronic devices (e.g., audio/visual media devices) begin to beacon their codes to allow a smart device to retrieve them 110. The codes can be broadcast via Bluetooth, Wi-Fi, or other wireless methods. In at least one embodiment, the electronic devices beacon their codes but not their names (e.g., model number, type of device, manufacturer). In at least one embodiment, the names of the electronic devices are in metadata that is not sent with their codes.

Upon entering range of the beaconed codes, the smart device can detect and negotiate with the media device(s) for all data pertaining to command and control 120. This can include codes, overlays, screens, graphic interfaces, etc. The smart device then uses this information to create and present a virtual URC tailored for command and control of the specific device(s) to the end user 130. The smart device can provide an interface to present to the end user with separate screens for each media device it is currently attached/tethered to 140. The virtual URC is then used by the end user to control the media devices as long as they are tethered 150. Upon untethering, the smart devices remove command and control information from the previous set up, allowing for the smart devices to negotiate for control upon encountering new media devices 160.

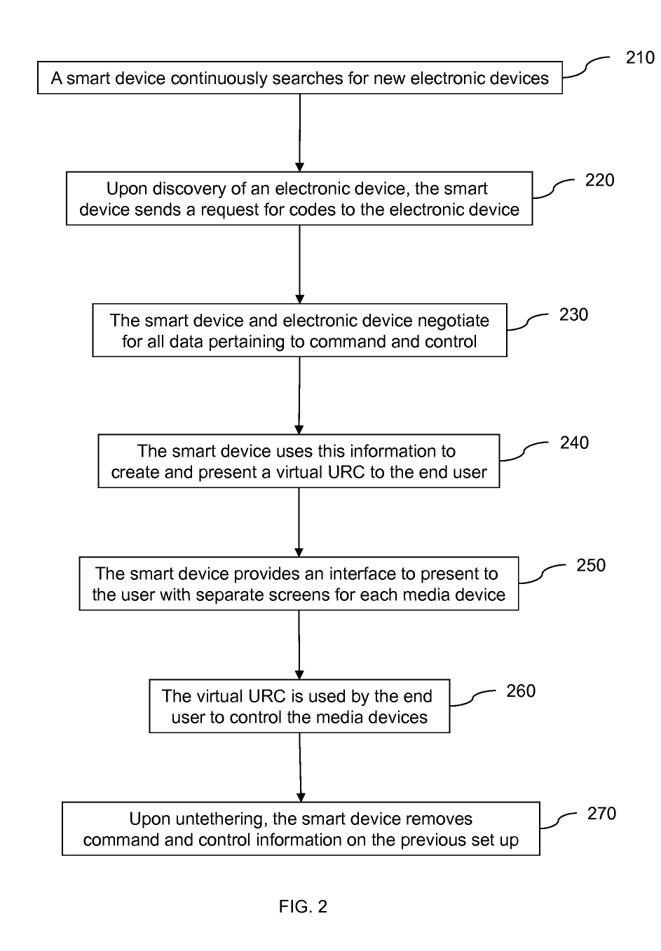

FIG. 2 is a flow diagram illustrating a method for controlling electronic devices according to another embodiment of the invention. A smart device continuously searches for new electronic devices 210. This can be performed via Bluetooth, Wi-Fi, or other wireless methods. Upon discovery of an electronic device, the smart device sends a request for codes to the electronic device 220.

The smart device and electronic device negotiates for all data pertaining to command and control, which can include codes, overlays, screens, GUI, etc. 230. The smart device then uses this information to create and present a virtual URC tailored for command and control of the specific device(s) to the end user 240.

The smart device provides an interface to present to the user with separate screens for each media device it is currently attached/tethered to 250. The virtual URC is then used by the end user to control the media devices as long as they are tethered 260. Upon untethering, the smart device removes command and control information on the previous set up, allowing the smart device to negotiate for control upon encountering new media devices 270.

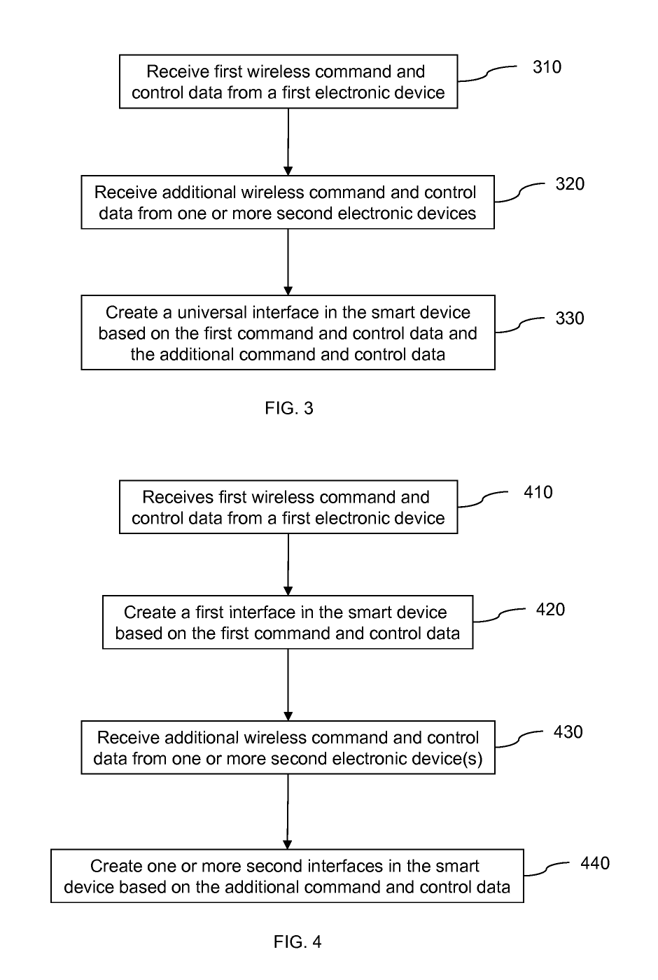

FIG. 3 is a flow diagram illustrating a method for controlling electronic devices according to another embodiment of the invention. As used herein, the term “electronic devices” includes audio media players (e.g., compact disk players, MP3 players, internet radios, satellite radios, etc.), audiovisual players (e.g., televisions, cable or satellite boxes or converters, DVD players, projectors, video game consoles, video recorders, etc.), lights, ceiling fans, floor fans, thermostats (heating and/or cooling systems), fireplaces, kitchen appliances (e.g., ovens, stoves, microwaves, etc.), and security systems.

A smart device receives first wireless command and control data from a first electronic device 310. As used herein, the term “smart device” includes smart phones, tablet computers, and laptop computers. In at least one embodiment, the first wireless command and control data are electronic signals that are received in an antenna of the smart device. As used herein, the term “antenna” includes a hardware device that receives electronic signals from a transmitter. The first command and control data can include one or more first menus for controlling the first media device (e.g., on a universal interface), and/or one or more first screen layouts for controlling the first media device (e.g., on a universal interface).

The first wireless command and control data can be automatically received from the first electronic device without input to the smart device from a user. In other words, the user does not have to manually input information (e.g., codes) into the smart device or otherwise perform any actions to initiate or gain control over electronic devices, with the exception of perhaps having to turn on or provide power to the smart device and/or electronic devices. Either the smart device actively searches or pings electronic devices for command and control data; or, the smart device passively receives command and control data from electronic devices that are actively beaconing their command and control data.

The smart device receives additional wireless command and control data from one or more second electronic devices 320. In at least one embodiment, the additional wireless command and control data is are electronic signals that are received in the antenna of the smart device. The additional command and control data includes one or more additional menus for controlling the second media device(s) (e.g., on a universal interface), and/or one or more additional screen layouts for controlling the second media device(s) (e.g., on the universal interface). The additional wireless command and control data is automatically received from the second electronic device(s) without input to the smart device from the user.

In at least one embodiment of the invention, upon entering range of the first electronic device, the smart device sends a first request to the first electronic device requesting the first wireless command and control data. Similarly, upon entering range with the second electronic device(s), the smart device can send an additional request to the second electronic device(s) requesting the additional wireless command and control data.

A universal interface is created in the smart device based on the first command and control data and the additional command and control data 330. The first electronic device and the second electronic device(s) are controllable by the universal interface. The universal interface can include multiple control menus that can be displayed on the smart device. The control menus can include control screens supplied by the first media device and/or the second media device(s). In at least one embodiment, the control menus and/or screens are displayed on a touchscreen display of the smart device. In another embodiment, the control menus and/or screens are on a display of the smart device, wherein the control menus can be navigated via buttons, keys, track balls, tabs, scrolling, and/or other like interfaces on the smart device.

The first control menus and control codes can be removed from the smart device when the smart device is out-of-range with the first electronic device. Similarly, the additional control menus and control codes can be removed from the smart device when the smart device is out-of-range with the second electronic device(s).

FIG. 4 is a flow diagram illustrating a method for controlling electronic devices according to another embodiment of the invention. A smart device receives first wireless command and control data from a first electronic device 410. The first wireless command and control data can include a first menu for controlling the first media device, and/or a first screen layout for controlling the first media device.

The first wireless command and control data can be automatically received from the first electronic device without input to the smart device from a user. In at least one embodiment, a first request is sent from the smart device to the first electronic device, wherein the first request requests the first wireless command and control data. A first interface is created in the smart device based on the first command and control data 420, wherein the first electronic device is controllable by the first interface.

The smart device receives additional wireless command and control data from one or more second electronic device(s) 430. The additional wireless command and control data can include one or more additional menus for controlling the second electronic device(s), and/or one or more additional screen layouts for controlling the second electronic device(s).

The additional wireless command and control data can be automatically received from the second electronic device(s) without input to the smart device from the user. In at least one embodiment, the smart device sends an additional request to the second electronic device(s), wherein the additional request requests the additional wireless command and control data. One or more second interfaces are created in the smart device based on the additional command and control data 440, wherein the second electronic device(s) are controllable by the second interface(s). In at least one embodiment, the first and second interfaces are created after the first and additional command and control data is received by the smart device.

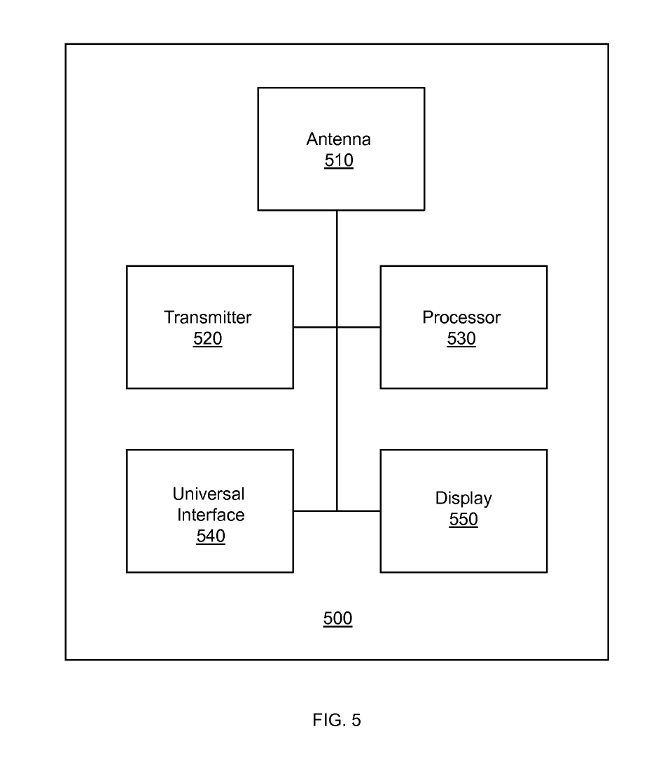

FIG. 5 illustrates a smart device 500 for controlling electronic devices according to an embodiment of the invention. The smart device 500 includes an antenna 510 for receiving first wireless command and control data from a first electronic device and additional wireless command and control data from one or more second electronic devices. The first wireless command and control data includes a first menu and/or a first screen layout for controlling the first electronic device. The additional wireless command and control data includes an additional menu and/or an additional screen layout for controlling the second electronic device(s).

In at least one embodiment of the invention, the antenna 510 receives the wireless command and control data and/or the additional wireless command and control data from the first electronic device and/or the second electronic device(s), respectively, automatically without input to the smart device 500 from a user. In another embodiment, the smart device 500 includes a transmitter 520 for sending a first request to the first electronic device, the first request requesting the first wireless command and control data. The transmitter 520 can also send additional request(s) to the second electronic device(s), the additional request(s) requesting the additional wireless command and control data.

A processor 530 is connected to the antenna 510 and/or transmitter 520, wherein the processor 530 creates a universal interface 540 based on the first command and control data and the additional command and control data. The universal interface 540 controls functions of the first electronic device and the second electronic device(s). For example, the universal interface 540 sends commands to the first electronic device and/or the second electronic device(s) via electronic signals transmitted through the transmitter 520. The commands can include, in the example of a DVD player, play, stop, pause, forward, reverse, next chapter, previous chapter, menu, etc.

The universal interface 540 can include multiple control menus having control screens supplied by the first electronic device and the second electronic device(s). More specifically, the multiple control menus can include one or more first control screens for controlling the first electronic device, and one or more additional control screens for controlling the second electronic device(s). The processor 530 can create the universal interface 540 based on command and control data most recently received by the smart device 500. The processor 530 can remove the first control screen from the smart device 500 when the smart device 500 is out-of-range of the first electronic device. Similarly, the processor 530 can remove the additional control screen from the smart device 500 when the smart device 500 is out-of-range of the at least one second electronic device.

The smart device 500 further includes a display 550 (e.g., touchscreen display) connected to the processor 530. The display 550 displays the universal interface 540 to a user. The display 550 can also receives user input (via a virtual keypad, voice recognition) to control the first electronic device and the second electronic device(s).

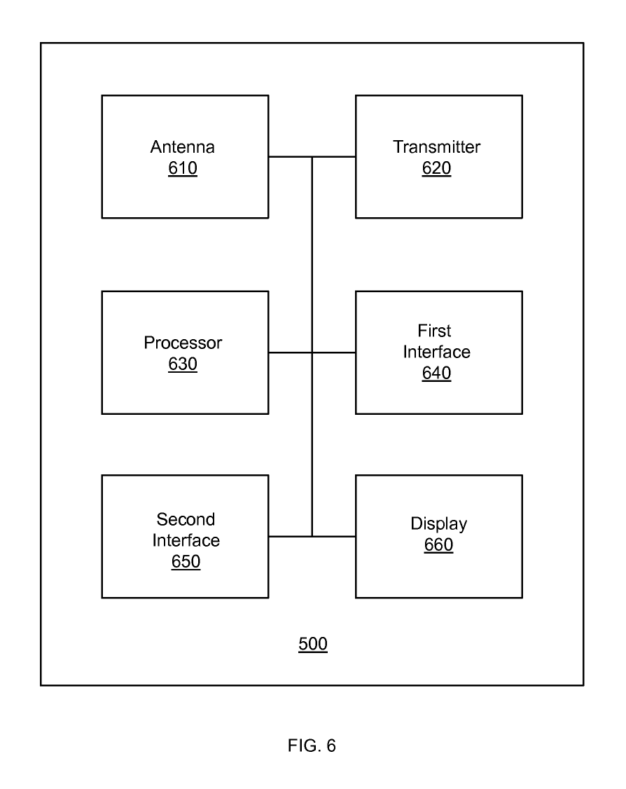

FIG. 6 illustrates a smart device 600 for controlling electronic devices according to another embodiment of the invention. The device 600 includes an antenna 610 for receiving first wireless command and control data from a first electronic device and additional wireless command and control data from at least one second electronic device. In at least one embodiment, the first wireless command and control data includes first menu(s) and/or first screen layout(s) for controlling the first electronic device. Similarly, the additional wireless command and control data can includes additional menu(s) and/or additional screen layout(s) for controlling the second electronic device(s).

In at least one embodiment of the invention, the antenna 610 receives the wireless command and control data from the first electronic device and/or the additional wireless command and control data from the second electronic device(s) automatically without input to the smart device 600 from a user. In another embodiment, the smart device 600 includes a transmitter 620 for sending a first request to the first electronic device, the first request requesting the first wireless command and control data. The transmitter 620 can also send additional request(s) to the second electronic device(s), the additional request(s) requesting the additional wireless command and control data.

A processor 630 is connected to the antenna 610, wherein the processor creates a first interface 640 based on the first wireless command and control data and a second interface 650 based on the additional wireless command and control data. The first interface controls functions of the first electronic device; and, the second interface controls functions of the second electronic device(s). For example, the first and second interfaces send commands to the electronic devices via electronic signals transmitted through the transmitter 620.

The first interface can include multiple control menus for displaying to the user, the control menus including control screens supplied by the first electronic device. Similarly, the second interface can include multiple second control menus for displaying to the user, the second control menus including second control screens supplied by the second electronic device(s). In other words, the multiple control menus can include one or more first control screens for controlling the first electronic device, and one or more additional control screens for controlling the second electronic device(s). The processor 630 can remove the first control screen and/or the additional control screen from the smart device 600 when the smart device 600 is out-of-range of the first electronic device and/or the second electronic device(s), respectively.

The smart device 600 also includes a display 660 (e.g., touchscreen display) connected to the processor 630, wherein the display 660 displays the first interface and/or the second interface to a user. The display 660 can receive user input (via a virtual keypad, voice recognition) to control the first electronic device and/or the second electronic device.

As will be appreciated by one skilled in the art, aspects of the present invention may be embodied as a system, method or computer program product. Accordingly, aspects of the present invention may take the form of an entirely hardware embodiment or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

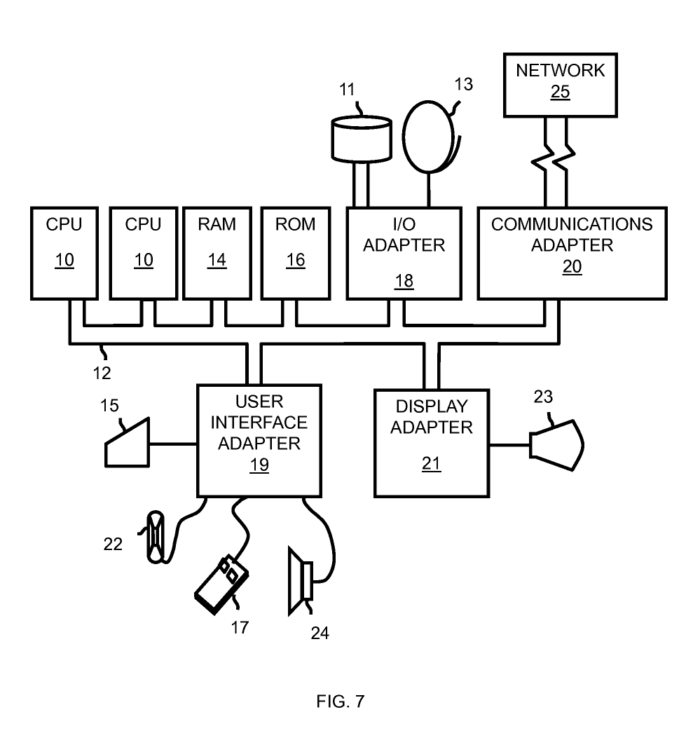

Referring now to FIG. 7, a representative hardware environment for practicing at least one embodiment of the invention is depicted. This schematic drawing illustrates a hardware configuration of an information handling/computer system in accordance with at least one embodiment of the invention. The system comprises at least one processor or central processing unit (CPU) 10. The CPUs 10 are interconnected with system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of at least one embodiment of the invention. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of at least one other feature, integer, step, operation, element, component, and/or groups thereof.

The corresponding structures, materials, acts, and equivalents of all means plus function elements in the claims below are intended to include any structure, or material, for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
receiving in an antenna of a smart device first wireless command and control data from a first electronic device;
receiving in the antenna of the smart device additional wireless command and control data from at least one second electronic device; and
creating a universal interface in the smart device based on the first command and control data and the additional command and control data, the first electronic device and the at least one second electronic device being controllable by the universal interface.

2. The method according to claim 1, wherein said receiving of the first wireless command and control data includes receiving the first wireless command and control data automatically from the first electronic device without input to the smart device from a user, and
said receiving of the additional wireless command and control data includes receiving the additional wireless command and control data automatically from the at least one second electronic device without input to the smart device from the user.

3. The method according to claim 1, further including at least one of:
sending a first request from the smart device to the first electronic device, the first request requesting the first wireless command and control data; and
sending an additional request from the smart device to the at least one second electronic device, the additional request requesting the additional wireless command and control data.

4. The method according to claim 1, wherein the universal interface includes multiple control menus for displaying on a display of the smart device, the control menus including control screens supplied by the first electronic device and the at least one second electronic device.

5. The method according to claim 4, wherein the multiple control menus include:
at least one first control screen for controlling the first electronic device; and
at least one additional control screen for controlling the at least one second electronic device.

6. The method according to claim 5, further comprising at least one of:
removing the first control screen from the smart device when the smart device is out-of-range of the first electronic device; and
removing the additional control screen from the smart device when the smart device is out-of-range of the at least one second electronic device.

7. The method according to claim 1, further including creating a universal interface in the smart device based on command and control data most recently received by the smart device.

8. The method according to claim 1, wherein the smart device includes at least one of a smart phone, a tablet computer, an e-reader, and a laptop computer.

9. The method according to claim 1, wherein the first electronic device includes at least one of a television, an audio player, and an audiovisual player, video recorder, light, ceiling fan, floor fan, thermostat, fireplace, kitchen appliance, and security system.

10. The method according to claim 1, wherein the first wireless command and control data includes at least one of a first menu for controlling the first electronic device on the universal interface, and a first screen layout for controlling the first electronic device on the universal interface, and
wherein the additional wireless command and control data includes at least one of an additional menu for controlling the at least one second electronic device on the universal interface, and an additional screen layout for controlling the at least one second electronic device on the universal interface.

11. A method comprising:
receiving in a smart device first electronic signals including first wireless command and control data from a first electronic device, the first wireless command and control data including a first menu for controlling the first electronic device, and a first screen layout for controlling the first electronic device;
receiving in the smart device additional electronic signals including additional wireless command and control data from at least one second electronic device, the additional wireless command and control data including an additional menu for controlling the at least one second electronic device, and an additional screen layout for controlling the at least one second electronic device; and
creating a universal interface in the smart device based on the first command and control data and the additional command and control data, the first electronic device and the at least one second electronic device being controllable by the universal interface, the universal interface including multiple control menus for displaying on a display of the smart device, the control menus including control screens supplied by the first electronic device and the at least one second electronic device.

12. The method according to claim 11, wherein said receiving of the first wireless command and control data includes receiving the first wireless command and control data automatically from the first electronic device without input to the smart device from a user, and
wherein said receiving of the additional wireless command and control data includes receiving the additional wireless command and control data automatically from the at least one second electronic device without input to the smart device from the user.

13. The method according to claim 11, further including:
upon entering range of the first electronic device, sending a first request from the smart device to the first electronic device, the first request requesting the first wireless command and control data; and
upon entering range of the at least one second electronic device, sending an additional request from the smart device to the at least one second electronic device, the additional request requesting the additional wireless command and control data.

14. The method according to claim 11, wherein the multiple control menus include:
at least one first control screen for controlling the first electronic device; and
at least one additional control screen for controlling the at least one second electronic device.

15. The method according to claim 14, further comprising:
removing first control menus and control codes from the smart device when the smart device is out-of-range of the first electronic device; and
removing additional control menus and control codes from the smart device when the smart device is out-of-range of the at least one second electronic device.

16. The method according to claim 11, further including creating a universal interface in the smart device based on command and control data most recently received by the smart device.

17. A method comprising:
receiving in a smart device first command and control data from a first electronic device, the first command and control data being received automatically from the first electronic device without input to the smart device from a user;
receiving in the smart device additional command and control data from at least one second electronic device, the additional command and control data being received automatically from the at least one second electronic device without input to the smart device from the user; and
creating a universal interface in the smart device based on the first command and control data and the additional command and control data, the first electronic device and the at least one second electronic device being controllable by the universal interface.

18. The method according to claim 17, further including at least one of:
sending a first request from the smart device to the first electronic device, the first request requesting the first command and control data; and
sending an additional request from the smart device to the at least one second electronic device, the additional request requesting the additional command and control data.

19. The method according to claim 17, wherein the universal interface includes multiple control menus for displaying on a display of the smart device, the control menus including control screens supplied by the first electronic device and the at least one second electronic device.

20. The method according to claim 19, wherein the multiple control menus include:
at least one first control screen for controlling the first electronic device; and
at least one additional control screen for controlling the at least one second electronic device.

21. The method according to claim 20, further comprising at least one of:
removing the first control screen from the smart device when the smart device is out-of-range with the first electronic device; and
removing the additional control screen from the smart device when the smart device is out-of-range with the at least one second electronic device.

22. A method comprising:
receiving in a smart device first wireless command and control data from a first electronic device;
creating a first interface in the smart device based on the wireless first command and control data, the first electronic device being controllable by the first interface;
receiving in the smart device additional wireless command and control data from at least one second electronic device; and
creating a second interface in the smart device based on the additional wireless command and control data, the at least one second electronic device being controllable by the second interface.

23. The method according to claim 22, wherein said receiving of the first wireless command and control data includes receiving the first wireless command and control data automatically from the first electronic device without input to the smart device from a user, and
wherein said receiving of the additional wireless command and control data includes receiving the additional wireless command and control data automatically from the at least one second electronic device without input to the smart device from the user.

24. The method according to claim 22, further including at least one of:
sending a first request from the smart device to the first electronic device, the first request requesting the first wireless command and control data; and
sending an additional request from the smart device to the at least one second electronic device, the additional request requesting the additional wireless command and control data.

25. The method according to claim 22, wherein the first wireless command and control data includes at least one of a first menu for controlling the first electronic device on the first interface, and a first screen layout for controlling the first electronic device on the first interface, and
wherein the additional wireless command and control data includes at least one of an additional menu for controlling the at least one second electronic device on the second interface, and an additional screen layout for controlling the at least one second electronic device on the second interface.
